(19) United States
(12) Patent Application Publication
(10) Pub. No.: US 2016/0379236 A1
(43) Pub. Date: Dec. 29, 2016

(54) METHOD AND SYSTEM FOR ESTIMATING RESIDENCE LATITUDE AND LONGITUDE WITH TRANSACTION DATA

(71) Applicant: MasterCard International Incorporated, Purchase, NY (US)

(72) Inventors: Harrison Reid SIEGEL, Glencoe, IL (US); Serge BERNARD, Danbury, CT (US); Nikhil MALGATTI, Stamford, CT (US)

(73) Assignee: MasterCard International Incorporated, Purchase, NY (US)

(21) Appl. No.: 15/181,936

(22) Filed: Jun. 14, 2016

Related U.S. Application Data
(60) Provisional application No. 62/183,955, filed on Jun. 24, 2015.

(51) Int. Cl. G06Q 30/02; H04L 29/08

(52) U.S. Cl. CPC G06Q 30/0205; H04L 67/18

(57) ABSTRACT

A method for estimating a consumer geolocation using filtered transaction data includes: storing transaction data entries, each including an account identifier, merchant identifier, and merchant category code; storing filtering rules, each including one or more merchant category codes; receiving a location request including a specific account identifier and specific filtering rule; identifying a subset of transaction data entries including the specific account identifier; filtering the subset of transaction data entries to remove transaction data entries where the merchant category code does not correspond to one of the merchant category codes included in the specific filtering rule; identifying a geographic location for each transaction data entry in the subset based on the respective included merchant identifier; estimating a geographic location based on the geographic location identified for each transaction data entry in the filtered subset; and electronically transmitting the estimated geographic location in response to the location request.

### FIELD

The present disclosure relates to the estimation of a consumer geolocation using transaction data, specifically the filtering of transactions based on merchant types and use of geolocations associated thereto for identification of consumer geolocations according to the filtered merchant types.

### BACKGROUND

The collecting of data regarding consumers has become a significantly large industry valued in the billions of dollars. Consumer data can be useful for a wide variety of entities for a wide variety of uses, such as research, advertising, product development, etc. For example, merchants may desire consumer information to determine who to advertise to, product manufacturers may desire consumer information to identify characteristics of their market, research firms may desire consumer information for use in identifying trends and behaviors, etc. One such piece of consumer information that may be beneficial for use by entities is a consumer's geographic location, or geolocation.

A consumer geolocation may be useful for the advertising of nearby merchants or products to a consumer, for identifying characteristics of a consumer based on their location and other sources of information (e.g., demographics of consumers in the area), and for predicting future behavior of the consumer, particularly in instances where geolocation information may be captured over time. As such, entities may be interested in identifying the geolocation of a consumer.

Many traditional methods identify a consumer's geolocation at a specific time, such as by identifying the geolocation of a mobile communication device that the consumer is in possession of. However, such methods can be resource intensive, costly, and may only be suitable for consumers who are both in possession of a suitable device and consent to sharing the location of their device. In addition, a consumer's geolocation at a particular time may not be reflective of an area at which the consumer may generally reside or be located, which may diminish the value of such data.

Some methods have been developed that estimate a centroid for a consumer based on their overall purchase history, by identifying a centroid of geographic locations associated with all of the payment transactions the consumer participates in. Detailed information regarding such methods can be found in U.S. patent application Ser. No. 13/721,216, entitled “Method and System for Assigning Spending Behaviors to Geographic Areas,” to Curtis Villars, filed on Dec. 20, 2012, which is herein incorporated by reference in its entirety. However, anomalies in consumer purchase history when taken as a whole may lead to centroids that are inaccurate for a consumer's geolocation. For example, regular transactions around both a home location and work location for a consumer, particularly in instances where a consumer may have a long commute, could lead to a centroid that is located between the consumer's work and home in an area where the consumer does not transact. In another example, a consumer may travel long distances for activities, such as hiking, sporting events, or entertainment, or may travel long distances to visit a specialized merchant, which may also drastically affect a centroid for the consumer.

Thus, there is a need for a technical system where payment transactions may be filtered using suitable criteria to select only those payment transactions that may be reflective of a geolocation to be identified for the consumer. However, because consumers may regularly transact at merchants that may not be located near a desired consumer geolocation, such as work, home, school, etc., a technical system may be needed where transactions are filtered not based on frequency, but on technical aspects of the payment transactions as can be identified in data captured as part of the transaction processing system.

### SUMMARY

The present disclosure provides a description of computer implemented systems and methods for estimating a consumer geolocation using filtered transaction data.

A method for estimating a consumer geolocation using filtered transaction data includes: storing, in a transaction database of a processing server, a plurality of transaction data entries, wherein each transaction data entry includes data related to a payment transaction including at least an account identifier, a merchant identifier, and a merchant category code; storing, in a rule database of the processing server, a plurality of filtering rules, wherein each filtering rule includes one or more merchant category codes; receiving, by a receiving device of the processing server, a data signal comprising a location request, wherein the location request includes at least a specific account identifier and indicates a specific filtering rule; executing, by a processing device of the processing server, a query on the transaction database to identify a subset of transaction data entries where the included account identifier corresponds to the specific account identifier included in the location request; filtering, by the processing device of the processing server, the identified subset of transaction data entries to remove transaction data entries where the included merchant category code does not correspond to one of the one or more merchant category codes included in the specific filtering rule indicated in the location request; identifying, by the processing device of the processing server, a geographic location for each transaction data entry in the filtered subset of transaction data entries based on the merchant identifier included in the respective transaction data entry; estimating, by the processing device of the processing server, a geographic location associated with the specific account identifier based on the geographic location identified for each transaction data entry in the filtered subset of transaction data entries; and electronically transmitting, by a transmitting device of the processing server, a data signal comprising the estimated geographic location associated with the specific account identifier in response to the location request.

A system for estimating a consumer geolocation using filtered transaction data includes a transaction database, a rule database, a receiving device, a processing device, and a transmitting device, each of a processing server. The transaction database is configured to store a plurality of transaction data entries, wherein each transaction data entry includes data related to a payment transaction including at least an account identifier, a merchant identifier, and a merchant category code. The rule database is configured to store a plurality of filtering rules, wherein each filtering rule includes one or more merchant category codes. The receiving device is configured to receive a data signal comprising a location request, wherein the location request includes at least a specific account identifier and indicates a specific filtering rule. The processing device is configured to: execute a query on the transaction database to identify a subset of transaction data entries where the included account identifier corresponds to the specific account identifier included in the location request; filter the identified subset of transaction data entries to remove transaction data entries where the included merchant category code does not correspond to one of the one or more merchant category codes included in the specific filtering rule indicated in the location request; identify a geographic location for each transaction data entry in the filtered subset of transaction data entries based on the merchant identifier included in the respective transaction data entry; and estimate a geographic location associated with the specific account identifier based on the geographic location identified for each transaction data entry in the filtered subset of transaction data entries. The transmitting device is configured to electronically transmit a data signal comprising the estimated geographic location associated with the specific account identifier in response to the location request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for estimating consumer geolocations using filtered transaction data in accordance with exemplary embodiments.

FIG. 2 is a block diagram illustrating the processing server of FIG. 1 for filtering transaction data and use thereof in estimating consumer geolocations in accordance with exemplary embodiments.

FIG. 3 is a flow diagram illustrating a process for filtering transaction data and estimating a consumer geolocation using the processing server of FIG. 2 in accordance with exemplary embodiments.

FIG. 4 is a diagram illustrating the estimation of a consumer geolocation based on transaction data and filtered transactions in accordance with exemplary embodiments.

FIG. 5 is a flow chart illustrating an exemplary method for estimating a consumer geolocation using filtered transaction data in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Estimation of Consumer Geolocations

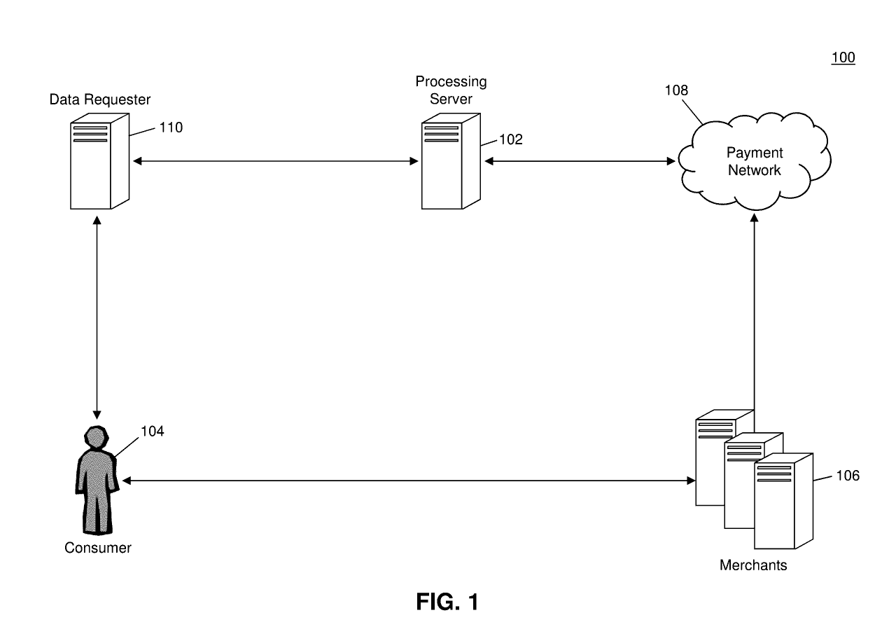

FIG. 1 illustrates a system 100 for the estimation of consumer geolocations using transaction data that has been filtered via technical details captured in the processing thereof.

The system 100 includes a processing server 102. The processing server 102, discussed in more detail below, may be configured to estimate geolocations for one or more consumers 104 using transaction data. As discussed below, the processing server 102 may identify transaction data associated with a consumer 104, filter the transaction data based on transaction details captured in the processing of the respective payment transactions using filtering rules, and estimate an associated geolocation for the consumer 104 based on geographic locations of merchants involved in each of the filtered transactions.

In the system 100, a consumer 104 may conduct payment transactions at a plurality of merchants 106. Payment transactions involving the merchants 106 may be processed by one or more payment networks 108 using traditional methods and systems that will be apparent to persons having skill in the relevant art. As part of the processing of payment transactions, the payment network 108 may receive a transaction message associated with the payment transaction. Transaction messages may be formatted pursuant to one or more associated standards, such as the International Organization of Standardization's ISO 8583 standard, and may be communicated using associated protocols, which may involve transmission using payment rails. Transaction messages may include a plurality of data elements configured to store data associated with the payment transaction, such as data elements configured to store primary account numbers, transaction times and/or dates, merchant identification numbers, financial institution identifiers, merchant category codes, transaction amounts, etc.

The payment network 108 may be configured to transmit transaction data to the processing server 102 for use in performing the methods discussed herein. In some embodiments, the payment network 108 may transmit transaction messages directly to the processing server 102 using payment rails associated with the payment network 108. In other embodiments, the payment network 108 may transmit data signals comprising the transaction data to the processing server 102 using alternative forms of communication, such as via the Internet. In some instances, the processing server 102 may be a part of the payment network 108 and may receive the transaction data via a local area network or during processing of payment transactions, such as receiving transaction messages directly from merchants 106 and/or financial institutions for the processing of the associated payment transactions.

The processing server 102 may store the transaction data for the payment transactions in a transaction database, discussed in more detail below. The processing server 102 may receive a request for a consumer geolocation, which may initiate the filtering of transaction data for a specific consumer 104 and use thereof in the estimation of a consumer geolocation. In some instances, the request may be electronically transmitted to the processing server 102 via a data signal from an external party or service, such as a data requester 110. The data requester 110 may be, for instance, the consumer 104, a merchant 106, an advertising agency, a data collection agency, a credit bureau, etc. In some cases, the request may be received via an input unit or terminal of the processing server 102, such as input by a user of the processing server 102. The request may specify the consumer 104 for which the geolocation is requested and the type of geolocation.

The processing server 102 may then identify payment transactions involving the specified consumer 104, as discussed in more detail below. Once the transactions have been identified, the processing server 102 may filter the transaction data to utilize only those transactions that are associated with the type of geolocation being requested based on filtering rules associated thereto. For example, the processing server 102 may utilize a different filtering rule for each type of geolocation, such as for identifying a consumer's home residence, place of employment, vacation residence, family member residences, school campus, etc. The filtering rules may be applied to the consumer's transactions for identification of a subset of transactions associated with the desired geolocation.

Once the transactions are filtered, the processing server 102 may identify a geolocation for each of the payment transactions. Geolocations may be included in the transaction data for each individual transaction, such as captured during the processing of the payment transaction (e.g. and stored in a data element of the associated transaction message), or may be identified via a lookup table or other suitable method using one or more data values in the transaction data or associated transaction message. For example, as discussed in more detail below, merchant identification data included in the transaction data may be used to identify a geographic location of a merchant involved in the transaction, which may be used as a geolocation for the transaction.

Once geolocations have been identified for each transaction, the processing server 102 may estimate a consumer geolocation based thereon. In some instances, transactions may be weighted for use in the estimation of a consumer geolocation. For example, if a consumer's residence is being estimated, filtered transactions may include eating places and fast food restaurants, where fast food restaurants may be weighted more heavily than eating places due to proximity to a consumer's residence being more prevalent in the selection of a fast food restaurant than an eating place.

The estimated consumer geolocation may be provided in response to the received data request. For instance, if the geolocation is requested by an external data requester 110, the processing server 102 may electronically transmit a data signal comprising the estimated geolocation to the data requester 110 in response to the request, and may use the same communication networks and/or channels for transmission thereof. In another instance, if the geolocation is requested by a user of the processing server 102, the estimated geolocation may be displayed on a display device of the processing server 102.

The estimated geolocation may be represented using latitude and longitude, or any other suitable manner of representing a geolocation, such as a street address, zip code, postal code, etc. In instances where latitude and longitude may be used to represent the estimated consumer geolocation, the number of decimal places included in the estimation may be based on the geographic area, population density thereof, and other factors that may be used to protect consumer privacy and security. For example, in a rural area where the consumer 104 whose home residence is being estimated is one of only a handful of people living in an area of several miles, zero or one decimal places may be used in the estimation of the geolocation, whereas, in a heavily populated area where thousands of consumers may reside in a single square mile, three decimal places may be used in the estimation of the geolocation. In each instance, the processing server 102 may be configured to utilize a number of decimal points such that the estimated geolocation is indicative of the consumer's geolocation, but may not identify an exact geolocation so as to protect the privacy of the consumer 104. For example, the geolocation may identify a block or neighborhood where ten or more consumers reside, such that an individual residence of the consumer 104 is not identified, in order to protect the privacy of the consumer 104 while retaining a high value of data.

The methods and systems discussed herein provide for the estimation of consumer geolocations that use transaction filtering to identify a consumer geolocation of a specific type based on the filtered transactions, that may achieve a level of specificity that is useful for third parties and yet protective of consumer privacy. By filtering the transaction data using data captured during the processing of the associated transactions, consumer geolocations can be estimated with a higher degree of accuracy than in traditional systems. In addition, by filtering transactions using different criteria, different geolocations may be identified, such as identifying a consumer's home residence, place of employment, etc., which traditional systems may be impossible using traditional systems.

### Processing Server

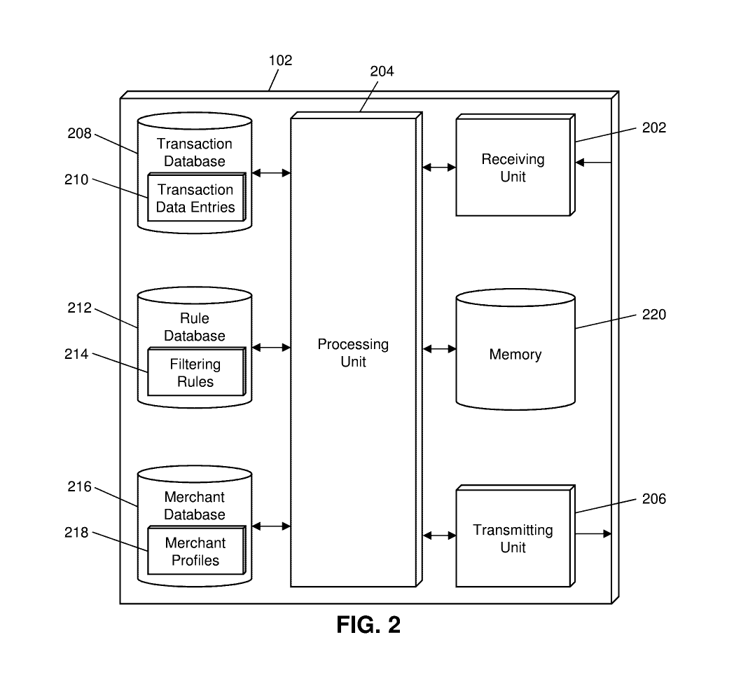

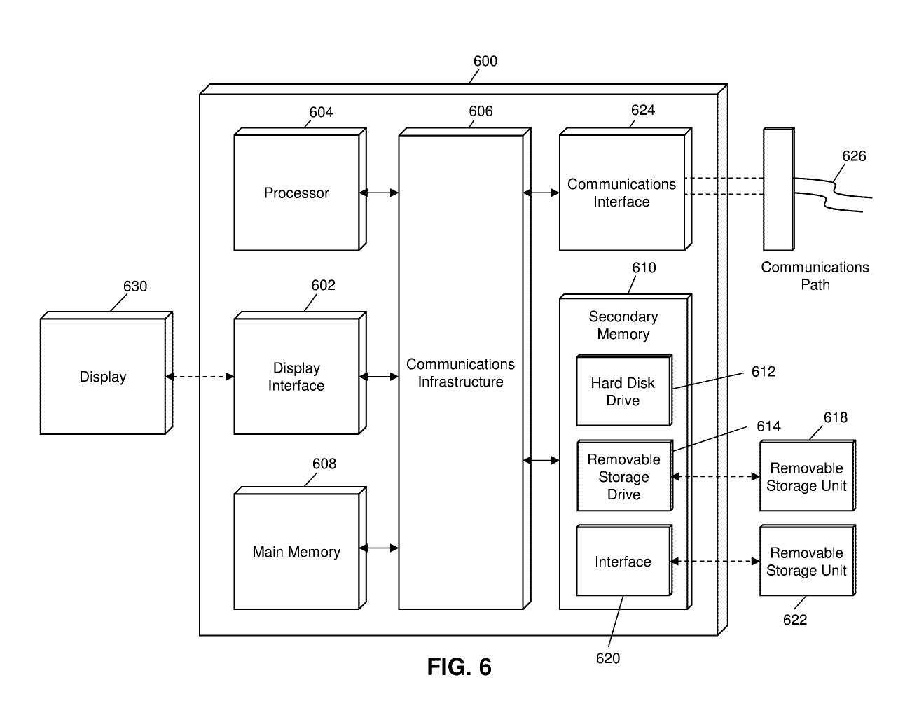

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive electronic transmissions of data signals from one or more entities or services, such as from the payment network 108 and data requesters 110. For example, the receiving unit 202 may be configured to receive transaction data for a plurality of payment transactions and data requests for requests of consumer geolocation estimations. In some instances, the receiving unit 202 may receive transaction messages transmitted by the payment network 108 via the payment rails, using associated communication protocols.

Transaction data received by the receiving unit 202 may be stored in a transaction database 208 of the processing server 102. The transaction database 208 may be configured to store a plurality of transaction data entries 210. Each transaction data entry 210 may be configured to store data related to a payment transaction. The data may include at least an account identifier, a merchant identifier, and a merchant category code. In some embodiments, each transaction data entry 210 may comprise a transaction message, which may include a plurality of data elements configured to store the data contained therein.

The account identifier may be a unique value associated with a transaction account used to fund the related payment transaction. The account identifier may be, for example, a primary account number, a controlled payment number, an e-mail address, a username, a phone number, etc. The merchant identifier may be a unique value associated with a merchant involved in the related payment transaction. The merchant identifier may be, for example, a merchant identification number (MID), a registration number, a primary account number, a controlled payment number, etc.

The merchant category code may be a value associated with the merchant involved in the related payment transaction that is indicative of a category of the merchant. Merchant category codes (MCCs) may be standardized values that may be set by a payment network 108 or other suitable entity that may be used across multiple payment networks 108, merchants 106, and other entities for use in categorizing merchants. MCCs may be numerical values that may be indicative of descriptive categories, or may be descriptive categories that are associated with respective numerical values. For example, an MCC may be “eating places and restaurants,” which may also be represented using the value “5812.” The use of MCCs will be apparent to persons having skill in the relevant art.

In some embodiments, each transaction data entry 210 may include additional data associated with the related payment transaction for use in performing the functions discussed herein. For example, each transaction data entry 210 may include a transaction time and/or date. In another example, a transaction data entry 210 may include a geolocation for the related payment transaction. The geolocation may be represented in latitude and longitude and may be a geolocation of the merchant involved in the payment transaction or a geolocation of a point of sale device used to initiate processing of the payment transaction. The geolocation may be captured at the point of sale, or may be identified during processing of the payment transaction, such as by the merchant 106, an associated financial institution (e.g., an acquiring bank), the payment network 108, or a third party.

The processing server 102 may also include a rule database 212. The rule database 212 may be configured to store a plurality of filtering rules 214. Each filtering rule 214 may include data suitable for use in filtering transaction data entries based on MCCs for use in the estimation of consumer geolocations. Each filtering rule 214 may include one or more MCCs, and may, in some instances, further include an indication of a geolocation type. For example, one filtering rule 214 may include a plurality of MCCs for estimating a home residence, while another filtering rule 214 may include a plurality of MCCs for estimating a place of employment.

In some embodiments, a filtering rule 214 may also include one or more additional criteria for use in filtering transaction data entries 210 using data included therein. For instance, a filtering rule 214 may include a period of times and/or dates. For example, a filtering rule 214 for estimating a place of employment may include an MCC corresponding to eating places and restaurants and an MCC corresponding to fast food restaurants, and may also include a time and/or date range for filtering transactions that occur outside of 8 am to 5 pm on weekdays. In another example, a filtering rule 214 may include a transaction amount, such as to filter out transactions above the included transaction amount to remove from consideration transactions for high-ticket items for which a consumer may be more likely to travel far away from their home residence. In some instances, additional criteria may be associated with a specific MCC included in a filtering rule 214.

The processing server 102 may further include a processing unit 204. The processing unit 204 may be configured to perform the functions of the processing server 102 discussed herein as will be apparent to persons having skill in the relevant art. The processing unit 204 may be configured to execute queries on the databases stored in the processing server 102 for use in performing the functions discussed herein. For example, the processing unit 204 may be configured to execute a query on the transaction database 208 to identify all transaction data entries 210 that include a specific account identifier associated with a consumer 104 for whom an estimated geolocation is requested (e.g., as indicated in a data request electronically received by the receiving unit 202).

Once a set of transaction data entries 210 for a consumer 104 have been identified, the processing unit 204 may also be configured to filter the transaction data entries 210 in the set by application of one or more of the filtering rules 214 stored in the rule database 212. In some instances, the data request may specify a filtering rule 214. In other instances, the processing unit 204 may determine what filtering rule 214 to apply, such as based on predetermined criteria, such as using a default filtering rule 214. The processing unit 204 may query the rule database 212 to identify the filtering rule 214 to apply to the set of transaction data entries 210. The processing unit 204 may then apply the filtering rule 214 to the set of transaction data entries 210 to filter out transaction data entries 210 from the set based on at least the MCCs included in the filtering rule 214 and the MCCs included in the transaction data entries 210.

Once the set has been filtered, the processing unit 204 may identify geolocations for each of the transaction data entries 210 remaining in the filtered set. In some embodiments, each transaction data entry 210 may include a geolocation in the respective transaction data. In other embodiments, the processing unit 204 may identify the geolocation for each transaction using a lookup table or other suitable method for identifying data associated with data included in the transaction data entry 210.

For example, in some instances the processing server 102 may include a merchant database 216. The merchant database 216 may include a plurality of merchant profiles 218. Each merchant profile 218 may include data related to a merchant 106 including at least an associated merchant identifier and an associated geographic location. The processing unit 204 may, for each transaction data entry 210 in the filtered set, execute a query on the merchant database 216 to identify a merchant profile 218 whose merchant identifier corresponds to the merchant identifier included in the respective transaction data entry 210. The associated geographic location may then be used as the geolocation for the respective transaction data entry 210.

Once geolocations for each transaction data entry 210 in the filtered set are identified, the processing unit 204 may estimate a geolocation for the associated transaction account (e.g., associated with the consumer 104) based on the geolocation for each of the transaction data entries 210 in the filtered set. The estimated geolocation may be calculated as the absolute average of each of the geolocations of the transactions, may be a centroid of the geolocations, may be a median of the geolocations, may be a geolocation associated with a majority of geolocations for the transactions in the set, etc. In some embodiments, a plurality of geolocations may be identified, such as a plurality of latitude and longitudes estimated based on a centroid of the geographic location. In such embodiments, the processing unit 204 may assign a likelihood to each geolocation, which may indicate a probability that the desired geolocation is at that latitude and longitude coordinate. Such a probability may be based on, for example, frequency of transactions, type of transactions, etc. For example, a higher frequency of transactions near one coordinate may lead to that coordinate having a higher probability assigned thereto. In another example, the filtering rule 214 may indicate weights for transactions based on data included therein, such as for each of the plurality of MCCs, which may be used to weight probabilities of each of the geolocations or for estimation of a single geolocation. For instance, for estimation of a home geolocation laundry, cleaning, and garment service transactions may be weighed more heavily than eating places and restaurants, due to a higher consumer likelihood to visit laundry services closer to their home residence.

In some embodiments, the estimated geolocation may be represented using latitude and longitude. In such embodiments, the level of specificity of the coordinate (e.g., number of decimal places) may be based on a population density for a geographic area including the estimated geolocation. For example, the processing unit 204 may estimate the consumer geolocation to one, two, or three decimal places based on the population density as to protect consumer privacy. For instance, the processing unit 204 may use enough decimal places to identify the associated consumer 104 as one of up to several dozen consumers at the geolocation, but also as one of at least a dozen or more consumers at the geolocation so as to protect consumer privacy by making an individual residence of the consumer 104 unidentifiable. In some embodiments, the level of specificity for the geolocation may be identified in the data request received by the receiving unit 202. In other embodiments, the processing server 102 may store the level of specificity for geographic areas and/or may identify the level of specificity for a geographic area including the geographic location as estimated, such as by requesting population density data from a third party.

Once the consumer geolocation or locations have been estimated by the processing unit 204, a transmitting unit 206 of the processing server 102 may electronically transmit a data signal comprising the estimate(s) in response to the received request. The transmitting unit 206 may be configured to electronically transmit data over one or more networks via one or more network protocols. The transmitting unit 206 may, for example, transmit a data signal comprising the estimated geolocation for the consumer 104 to the data requester 110 in response to the received data request using the same communication network and protocol used in the transmission of the request, such as the Internet. Other suitable types of networks and protocols for the electronic transmission of data comprising estimated geolocations will be apparent to persons having skill in the relevant art.

The processing server 102 may also include a memory 220. The memory 220 may be configured to store data suitable for use by the processing server 102 in performing the functions discussed herein. For example, the memory 220 may include one or more of the databases of the processing server 102 discussed herein, rules or algorithms for estimating geolocations based on transaction geolocations, rules or algorithms for weighting transactions, rules or algorithms for estimating probabilities of geolocations, population density values, rules or algorithms for identifying population density, etc. Additional data that may be stored in the memory 220 will be apparent to persons having skill in the relevant art.

### Method for Filtering Transaction Data and Estimating Geolocations

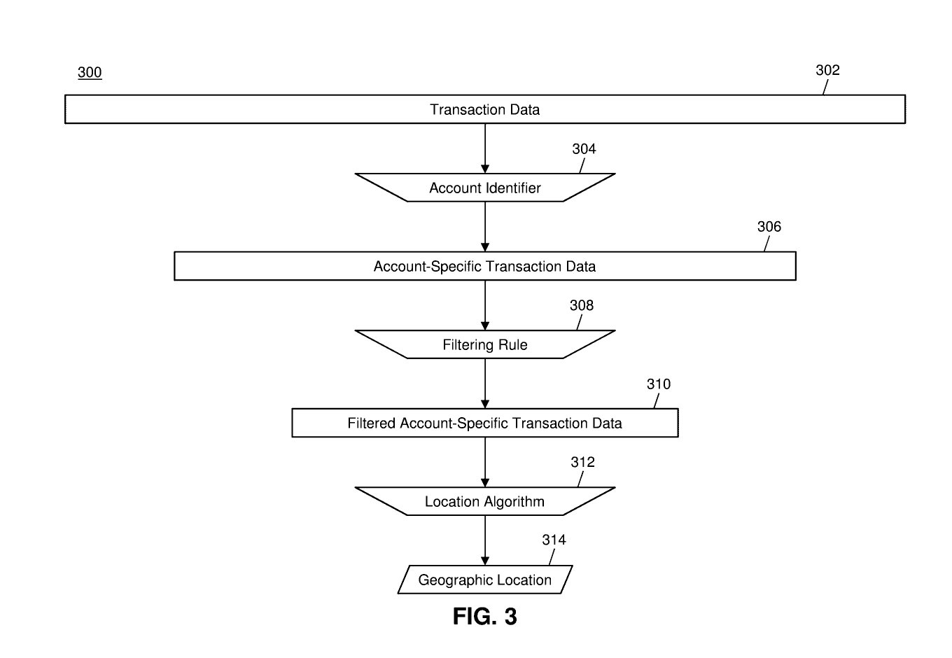

FIG. 3 illustrates a method 300 for the filtering of transaction data for a consumer 104 using filtering rules in order to estimate an associated consumer geolocation.

The method 300 may include the identification and filtering of transaction data 302. The transaction data 302 may include a plurality of transaction data entries 210, such as stored in the transaction database 208 of the processing server 102. Each transaction data entry 210 in the transaction data 302 may include at least an account identifier, a merchant identifier, and a merchant category code. A specific account identifier 304 may be applied to the transaction data 302 in order to identify transactions associated with a specific consumer 104. The account identifier 304 may be a specific account identifier associated with a transaction account associated with the consumer 104. The account identifier 304 may be included in a data request electronically transmitted to the processing server 102 and received by the receiving unit 202 of the processing server 102.

The processing unit 204 of the processing server 102 may execute a query on the transaction data 302 to identify the transaction data entries 210 included therein that include an account identifier that corresponds to the account identifier 304. The resulting transaction data entries 210 may comprise account-specific transaction data 306. The account-specific transaction data 306 may thus be a subset of the transaction data 302 that includes only the transaction data for transactions involving the consumer 104 associated with the account identifier 304.

A filtering rule 308 may then be used in order to filter the account-specific transaction data 306. The filtering rule 308 may be indicated in the received data request or may be identified by the processing unit 202. The filtering rule 308 may be one of the filtering rules 214 stored in the rule database 212 and include a plurality of MCCs. The processing unit 204 may apply the filtering rule to the account-specific transaction data 306 to filter out any transaction data entry 210 where the included MCC does not correspond to one of the plurality of MCCs in the filtering rule 308. The transaction data entries 210 that are remaining may comprise filtered account-specific transaction data 310, and may correspond to only those transactions involving the consumer 104 that are suitable for estimating a geolocation associated with the filtering rule 308.

Once the filtered account-specific transaction data 310 is identified, the processing unit 204 may apply one or more location algorithms 312 (e.g., stored in the memory 220 of the processing server 102) to the transactions to estimate a geographic location 314. In some embodiments, the location algorithms 312 may be directly applied to the transaction data entries 210 comprising the filtered account-specific transaction data 310, such as in embodiments where each transaction data entry 210 includes a geographic location. In other embodiments, the processing unit 204 may first identify a geographic location for each transaction data entry 210 in the filtered account-specific transaction data 310, such as by identifying an associated merchant profile 218 in the merchant database 216 and using the geographic location included therein. The geographic location 314 that is estimated via use of the location algorithm 312 may then be electronically transmitted by the transmitting unit 206 in response to the received data request.

### Estimated Geolocation Using Filtered Transaction Data

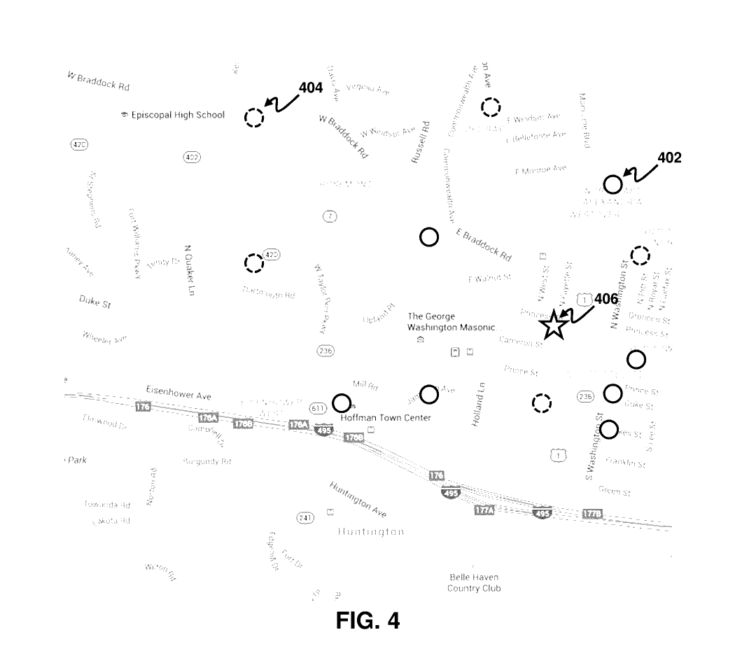

FIG. 4 illustrates the estimation of a consumer geolocation from filtered transaction data using the methods and systems discussed herein.

FIG. 4 illustrates a map of a geographic area, where the map includes a plurality of transactions indicated by circles on the map. The map includes transactions 402 and 404 that comprise a plurality of transactions involving a consumer 104. As discussed above, the processing unit 204 of the processing server 102 may be configured to filter out transactions for use in the estimation of a geolocation based on the application of a filtering rule 214 to the transaction data, which may filter the transactions based on MCCs and any other suitable criteria, such as time, date, transaction amount, etc.

In the example illustrated in FIG. 4, the processing unit 204 may apply a filtering rule 214 to the transaction data and may identify transactions 404 to be filtered out from consideration in the estimation of the consumer geolocation. For example, if the consumer geolocation being estimated is the consumer's home residence, the transactions 402 may correspond to transactions whose MCCs include grocery stores, supermarkets, laundry services, fast food restaurants, and drug stores, while the transactions 404 may correspond to transactions whose MCCs are not included in the filtering rule 214, such as sporting goods stores, craft stores, and home improvement stores.

Once the transactions are filtered such that the transactions 402 remain to be used, the processing unit 204 may estimate a consumer geolocation 406 based on the geolocations of each of the transactions 402. As illustrated in FIG. 4, the consumer geolocation 406 may be a centroid based on each of the geolocations of the transactions 402. In other embodiments, the consumer geolocation 406 may be an absolute average of each of the geolocations of transactions 402, or may be affected by weighting of the transactions 402.

As also illustrated in FIG. 4, the consumer geolocation 406 may correspond to a latitude and longitude coordinate. The processing unit 204 may identify a population density for the geographic area including the consumer geolocation 406 and may represent the consumer geolocation 406 accordingly to protect consumer privacy. For example, if the consumer geolocation 406 indicates an area including less than ten consumers, the processing unit 204 may expand the area indicated by the consumer geolocation 406, such as by removing a decimal place from the latitude and longitude representation or rounding.

### Exemplary Method for Estimating a Consumer Geolocation Using Filtered Transaction Data

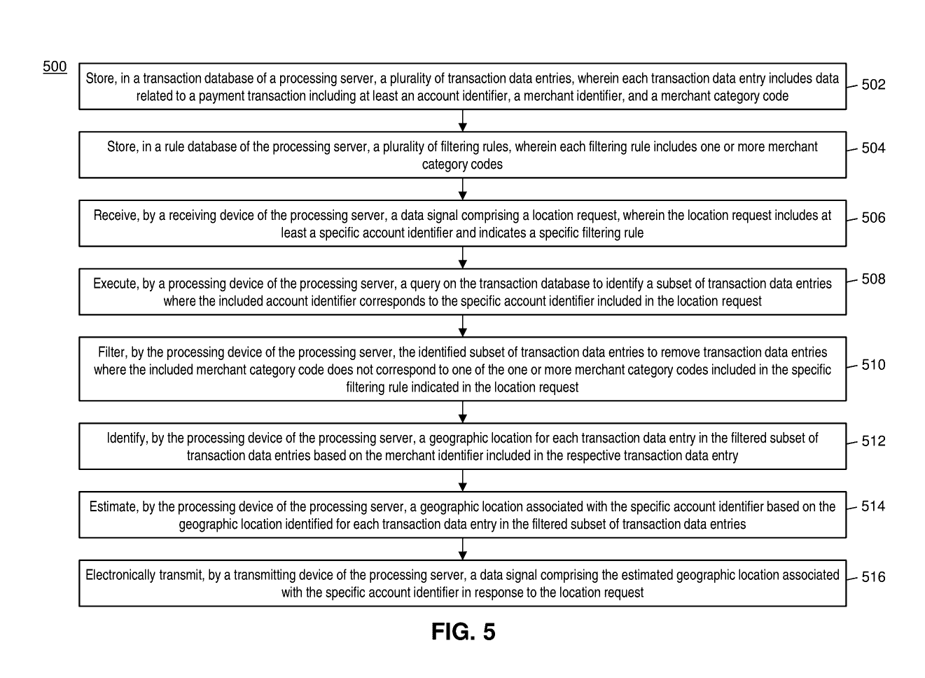

FIG. 5 illustrates a method 500 for the estimation of a consumer geolocation using geographic locations for transactions that have been filtered based on data captured in the processing of the associated payment transactions.

In step 502, a plurality of transaction data entries (e.g., transaction data entries 210) may be stored in a transaction database (e.g., the transaction database 208) of a processing server (e.g., the processing server 102), wherein each transaction data entry includes data related to a payment transaction including at least an account identifier, a merchant identifier, and a merchant category code. In one embodiment, each transaction data entry may comprise a transaction message formatted based on one or more standards, the included data being stored in one or more of a plurality of data elements included in the respective transaction message. In a further embodiment, the one or more standards may include the ISO 8583 standard.

In step 504, a plurality of filtering rules (e.g., filtering rules 214) may be stored in a rule database (e.g., the rule database 212) of the processing server, wherein each filtering rule includes one or more merchant category codes. In some embodiments, the one or more merchant category codes may include at least one of: grocery stores, drug stores, supermarkets, department stores, eating places and restaurants, fast food restaurants, and laundry, cleaning, and garment services. In step 506, a data signal comprising a location request may be received by a receiving device (e.g., the receiving unit 202) of the processing server, wherein the location request includes at least a specific account identifier and indicates a specific filtering rule.

In step 508, a query on the transaction database may be executed by a processing device (e.g., the processing unit 204) of the processing server to identify a subset of transaction data entries where the included account identifier corresponds to the specific account identifier included in the location request. In one embodiment, each transaction data entry may further include a transaction date, the location request may further include a period of time, and each transaction data entry in the identified subset may include a transaction date within the period of time included in the location request.

In step 510, the identified subset of transaction data entries may be filtered by the processing device of the processing server to remove transaction data entries where the included merchant category code does not correspond to one of the one or more merchant category codes included in the specific filtering rule indicated in the location request. In one embodiment, each transaction data entry may further include a transaction time and/or date, each filtering rule may include one or more time and/or date ranges, and filtering the identified subset of transaction data entries may further include removing transaction data entries where the included transaction time and/or date is outside of each of the one or more time and/or date ranges included in the indicated specific filtering rule.

In step 512, a geographic location may be identified by the processing device of the processing server for each transaction data entry in the filtered subset of transaction data entries based on the merchant identifier included in the respective transaction data entry. In one embodiment, each transaction data entry may further include a geographic location associated with a merchant associated with the included merchant identifier, and identifying the geographic location for each transaction data entry may include identifying the geographic location included in the respective transaction data entry. In another embodiment, a plurality of merchant profiles (e.g., merchant profiles 218) may be stored in a merchant database (e.g., the merchant database 216) of the processing server, wherein each merchant profile includes data related to a merchant including at least a merchant identifier and a geographic location, and wherein identifying the geographic location for each transaction data entry includes identifying, for each transaction data entry, the geographic location stored in a merchant profile where the included merchant identifier corresponds to the merchant identifier included in the respective transaction data entry.

In step 514, a geographic location associated with the specific account identifier may be estimated by the processing device of the processing server based on the geographic location identified for each transaction data entry in the filtered subset of transaction data entries. In one embodiment, the estimated geographic location may be represented using latitude and longitude. In a further embodiment, a number of decimal places included in the latitude and longitude is based on a density associated with the geographic location. In step 516, a data signal comprising the estimated geographic location associated with the specific account identifier may be transmitted by a transmitting device (e.g., the transmitting unit 206) of the processing server in response to the location request.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for estimating consumer geolocations using filtered transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for estimating a consumer geolocation using filtered transaction data, comprising:
storing, in a transaction database of a processing server, a plurality of transaction data entries, wherein each transaction data entry includes data related to a payment transaction including at least an account identifier, a merchant identifier, and a merchant category code;
storing, in a rule database of the processing server, a plurality of filtering rules, wherein each filtering rule includes one or more merchant category codes;
receiving, by a receiving device of the processing server, a data signal comprising a location request, wherein the location request includes at least a specific account identifier and indicates a specific filtering rule;
executing, by a processing device of the processing server, a query on the transaction database to identify a subset of transaction data entries where the included account identifier corresponds to the specific account identifier included in the location request;
filtering, by the processing device of the processing server, the identified subset of transaction data entries to remove transaction data entries where the included merchant category code does not correspond to one of the one or more merchant category codes included in the specific filtering rule indicated in the location request;
identifying, by the processing device of the processing server, a geographic location for each transaction data entry in the filtered subset of transaction data entries based on the merchant identifier included in the respective transaction data entry;
estimating, by the processing device of the processing server, a geographic location associated with the specific account identifier based on the geographic location identified for each transaction data entry in the filtered subset of transaction data entries; and
electronically transmitting, by a transmitting device of the processing server, a data signal comprising the estimated geographic location associated with the specific account identifier in response to the location request.

2. The method of claim 1, wherein each of the transaction data entries comprises a transaction message formatted based on one or more standards, the included data being stored in one or more of a plurality of data elements included in the respective transaction message.

3. The method of claim 2, wherein the one or more standards includes the ISO 8583 standard.

4. The method of claim 1, wherein
each transaction data entry further includes a transaction date,
the location request further includes a period of time, and
each transaction data entry in the identified subset includes a transaction date within the period of time included in the location request.

5. The method of claim 1, wherein the one or more merchant category codes included in the indicated specific filtering rule includes at least one of: grocery stores, drug stores, supermarkets, department stores, eating places and restaurants, fast food restaurants, and laundry, cleaning, and garment services.

6. The method of claim 1, wherein
each transaction data entry further includes a transaction time and/or date,
each filtering rule includes one or more time and/or date ranges, and
filtering the identified subset of transaction data entries further includes removing transaction data entries where the included transaction time and/or date is outside of each of the one or more time and/or date ranges included in the indicated specific filtering rule.

7. The method of claim 1, wherein
each transaction data entry further includes a geographic location associated with a merchant associated with the included merchant identifier, and
identifying the geographic location for each transaction data entry in the filtered subset further includes identifying the geographic location included in the respective transaction data entry.

8. The method of claim 1, further comprising:
storing, in a merchant database of the processing server, a plurality of merchant profiles, wherein each merchant profile includes data related to a merchant including at least a merchant identifier and a geographic location, wherein
identifying the geographic location for each transaction data entry in the filtered subset includes identifying, for each transaction data entry, the geographic location stored in a merchant profile where the included merchant identifier corresponds to the merchant identifier included in the respective transaction data entry.

9. The method of claim 1, wherein the estimated geographic location is represented using latitude and longitude.

10. The method of claim 9, wherein a number of decimal places included in the latitude and longitude is based on a density associated with the geographic location.

11. A system for estimating a consumer geolocation using filtered transaction data, comprising:
a transaction database of a processing server configured to store a plurality of transaction data entries, wherein each transaction data entry includes data related to a payment transaction including at least an account identifier, a merchant identifier, and a merchant category code;
a rule database of the processing server configured to store a plurality of filtering rules, wherein each filtering rule includes one or more merchant category codes;
a receiving device of the processing server configured to receive a data signal comprising a location request, wherein the location request includes at least a specific account identifier and indicates a specific filtering rule;
a processing device of the processing server configured to
execute a query on the transaction database to identify a subset of transaction data entries where the included account identifier corresponds to the specific account identifier included in the location request,
filter the identified subset of transaction data entries to remove transaction data entries where the included merchant category code does not correspond to one of the one or more merchant category codes included in the specific filtering rule indicated in the location request,
identify a geographic location for each transaction data entry in the filtered subset of transaction data entries based on the merchant identifier included in the respective transaction data entry, and
estimate a geographic location associated with the specific account identifier based on the geographic location identified for each transaction data entry in the filtered subset of transaction data entries; and
a transmitting device of the processing server configured to electronically transmit a data signal comprising the estimated geographic location associated with the specific account identifier in response to the location request.

12. The system of claim 11, wherein each of the transaction data entries comprises a transaction message formatted based on one or more standards, the included data being stored in one or more of a plurality of data elements included in the respective transaction message.

13. The system of claim 12, wherein the one or more standards includes the ISO 8583 standard.

14. The system of claim 11, wherein
each transaction data entry further includes a transaction date,
the location request further includes a period of time, and
each transaction data entry in the identified subset includes a transaction date within the period of time included in the location request.

15. The system of claim 11, wherein the one or more merchant category codes included in the indicated specific filtering rule includes at least one of: grocery stores, drug stores, supermarkets, department stores, eating places and restaurants, fast food restaurants, and laundry, cleaning, and garment services.

16. The system of claim 11, wherein
each transaction data entry further includes a transaction time and/or date,
each filtering rule includes one or more time and/or date ranges, and
filtering the identified subset of transaction data entries further includes removing transaction data entries where the included transaction time and/or date is outside of each of the one or more time and/or date ranges included in the indicated specific filtering rule.

17. The system of claim 11, wherein
each transaction data entry further includes a geographic location associated with a merchant associated with the included merchant identifier, and
identifying the geographic location for each transaction data entry in the filtered subset further includes identifying the geographic location included in the respective transaction data entry.

18. The system of claim 11, further comprising:
a merchant database of the processing server configured to store a plurality of merchant profiles, wherein each merchant profile includes data related to a merchant including at least a merchant identifier and a geographic location, wherein
identifying the geographic location for each transaction data entry in the filtered subset includes identifying, for each transaction data entry, the geographic location stored in a merchant profile where the included merchant identifier corresponds to the merchant identifier included in the respective transaction data entry.

19. The system of claim 11, wherein the estimated geographic location is represented using latitude and longitude.

20. The system of claim 19, wherein a number of decimal places included in the latitude and longitude is based on a density associated with the geographic location.
